(19) United States
(12) Patent Application Publication
(10) Pub. No.: US 2012/0042855 A1
(43) Pub. Date: Feb. 23, 2012

(54) ULTRA LOW POWER MARINE FUEL POSLISHING SYSTEM

(75) Inventors: JAMES VOGELY, Yorktown, VA (US); Steve Knight, Portland, CT (US)

(73) Assignee: PARKER HANNIFIN CORPORATION, Cleveland, OH (US)

(21) Appl. No.: 12/859,827

(22) Filed: Aug. 20, 2010

(51) Int. Cl. F02M 37/04; F04B 35/04

(52) U.S. Cl. 123/498; 417/410.1

(57) ABSTRACT

A diesel engine fuel polishing system is provided that utilizes a piezoelectric pump to circulate fuel from a fuel tank and through a filter and then back to the fuel tank. The piezoelectric pump operates on ultra low power and can be utilized in continuous operation when the diesel engine is not in operation. The low power requirement allows the pump to be operated by a battery that is recharged by a solar energy panel.

### CROSS REFERENCE TO RELATED CASES

This application is a continuation of International Patent Application No. PCT/US2009/033041, which claims the benefit of U.S. Provisional Application Ser. No. 61/025,980 filed Feb. 4, 2008, which is herein incorporated by reference.

### TECHNICAL FIELD

The present invention relates, in general, to marine fuel polishing systems, and in particular to a piezoelectric pump utilized to circulate fuel through a fuel polishing system under low power conditions.

### BACKGROUND

Often boats sit idle for long periods of time which can result in contamination of the fuel in the fuel tank and fuel lines. Diesel fuel can easily become contaminated with microorganisms such as bacteria, fungi, yeast, mold, and algae. Diesel fuel in the presence of water and nutrients makes conditions ripe for high bacterial growth. Water and microbes can be introduced from the outside air, from the filling station, or most commonly, from changes in storage temperatures, which causes condensation to occur within the tank. Water allowed to remain in fuel will culture a microorganism or bacteria that feeds on the hydrocarbons in the fuel, therefore degrading the fuel quality. Water can also allow algae to grow in the tank, typically adhering to the wall of the tanks. When the boat is operated and the fuel begins moving around—the contamination tends to break away from the wall of the tank and enters the fuel. This contamination can clog fuel filters and even shut down the engines. Accordingly, water is the worst and most common form of fuel contamination.

In order to combat water contamination, prior art fuel polishing systems have been developed to filter the fuel even when the engine is not running. These prior art systems utilize an independent fuel pump that continuously pulls fuel from the tank, through the filter, and back to the tank. However, these systems utilize traditional pumping technology that requires that the boat is hooked up to power at a dock due to the high power consumption of the pumps. Power may not always be available at the dock and is not available if the boat is on moorings.

### SUMMARY

At least one embodiment of the invention provides a fuel polishing system comprising: a fuel tank having a fuel supply line and a fuel return line; a fuel filter attached to the fuel supply line; a piezoelectric pump selectively controlled to pump fuel from the fuel tank and through the filter and return the fuel to the fuel tank by directing the fuel to the fuel return line.

At least one embodiment of the invention provides A fuel polishing system comprising: a fuel tank having a fuel supply line for supplying fuel to a diesel engine and a fuel return line for returning fuel from the diesel engine to the fuel tank; a fuel filter attached to the fuel supply line; a fuel polishing module attached to the fuel supply line, the fuel polishing module comprising a piezoelectric pump adapted to pump fuel from the fuel tank and through the filter and return the fuel to the fuel tank by directing the fuel to the fuel return line, the fuel polishing module including a by-pass line to direct fuel around the piezoelectric pump when the diesel engine is in operation.

### BRIEF DESCRIPTION OF THE DRAWINGS

Embodiments of this invention will now be described in further detail with reference to the accompanying drawing, in which:

FIG. 1 is a schematic view of a first embodiment of the ultra low power fuel polishing system in accordance with the present invention;

FIG. 2 is a schematic view of a second embodiment of the ultra low power fuel polishing system in accordance with the present invention.

FIG. 3 is a schematic view of a the fuel polishing module used with the ultra low power fuel polishing system of FIG. 2; and

FIG. 4 is a schematic view of a solar power source and timer switch used with the fuel polishing module; and

FIG. 5 is a schematic view of a solar power source and sealed switch used with the fuel polishing module.

### DETAILED DESCRIPTION OF THE DRAWINGS

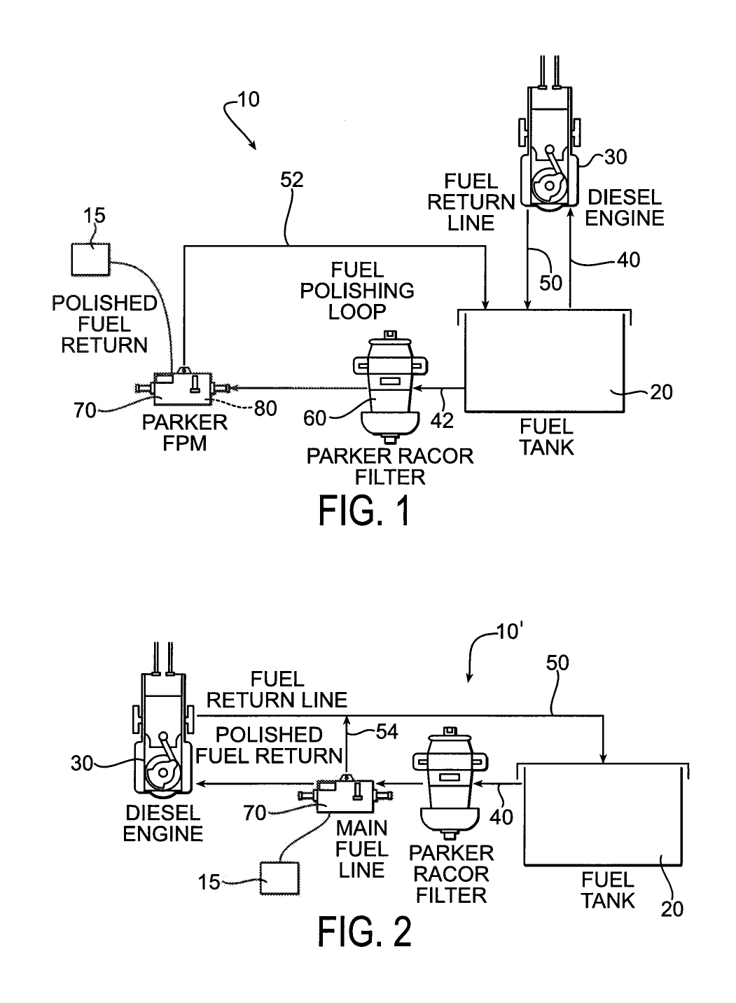

A dedicated low power fuel polishing system 10 is shown in FIG. 1. The system 10 comprises a fuel tank 20 which is separately fluidly connected to a diesel engine 30 by a fuel supply line 40 and a fuel return line 50. The fuel tank 20 is also fluidly connected by a dedicated fuel polishing supply line 42 and a dedicated fuel return line 52. A fuel filter 60 is attached to the fuel polishing supply line 42 such that fuel coming from the fuel tank 20 is filtered. A fuel polishing module 70 is attached to an outlet of the fuel filter 60 and is controlled by a remote pump controller/timer 80 (shown housed within the fuel polishing module). The fuel polishing module 70 is attached to a power source 15, typically a battery. The fuel polishing module 70 also includes an ultra low power pump such as a piezoelectric fluid pump. As directed by the controller 80, the piezoelectric pump of the fuel polishing module 70 can continuously pull fuel from the fuel tank 20, through the fuel filter 60, and back to the fuel tank 20.

An inline low power fuel polishing system 10′ is shown in FIG. 2. The system 10′ comprises a fuel tank 20 fluidly connected to a diesel engine 30 by a fuel supply line 40 and a fuel return line 50. A fuel filter 60 is attached to the fuel supply line 40 such that fuel coming from the fuel tank 20 is filtered. A fuel polishing module 70 is attached to an outlet of the fuel filter 60 and is controlled by a remote pump controller/timer 80. As directed by the controller 80, the piezoelectric pump of the fuel polishing module 70 can continuously pull fuel from the fuel tank 20, through the fuel filter 60, and back to the fuel tank 20 through diverter line 54 and fuel return line 50. The fuel polishing module 70 is attached to a power source 15, typically a battery.

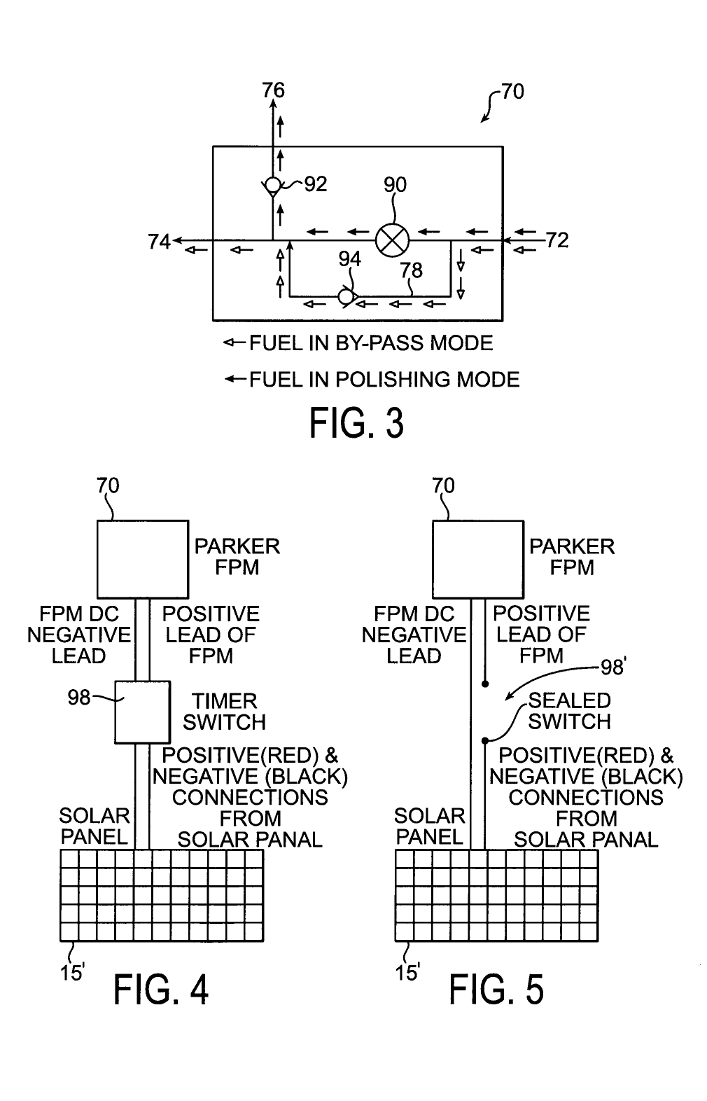

The fuel polishing module 70 is shown schematically in FIG. 3 and includes a fuel inlet 72, an engine fuel outlet 74, and a fuel tank return outlet 76 for the fuel diverter line. The fuel polishing module 70 also comprises an ultra low power pump 90 in the form of a piezoelectric pump. When the engine 30 is not operating, the pump 90 is turned on by the controller 80 and pulls fuel from the fuel tank 20 through the filter 60 and into the fuel inlet 72. The fuel is pumped back to the fuel tank 20 through the fuel tank return outlet 76. When the engine 30 is operating, the fuel polishing module automatically switches to by-pass mode. The pump 90 is turned off and the fuel travels through the fuel by-pass line 78 around the pump 90 and exits module 70 through the engine fuel outlet. Check valve 92 is positioned in the diverted fuel line before outlet 76 and check valve 94 is positioned in the by-pass line 78 to ensure proper fuel flow within the fuel polishing module 70 and system 10′.

The piezoelectric pump 90 requires only minimal power for operation in comparison to pumps utilized in prior art fuel polishing systems. Accordingly, the system 10 of the present invention can operate on the boat's battery, or a supplemental battery. At least one system has been developed to pump about 50 gallons per day and operate on less than one Watt (less than two Amp-hours per day). Another system has been developed to pump about 100 gallons per day and operate on less than two Watts (less than three Amp-hours per day). This power consumption represents less than five percent of the capacity of a standard Group 27 battery. Battery operation allows the system to run even when no shore power is available or when the boat is moored. A suitable pump can be made utilizing RLP™ piezoelectric disk from the AdaptivEnergy LLC. Another alternative is utilizing the VIVA™ piezoelectric pump from Parker Hannifin Corporation.

As an alternative, the pump 90 may be powered for continuous operation by solar power. Referring now to FIGS. 4 and 5, the fuel polishing module 70 is shown connected to a solar panel 15′. A timer switch 98 or sealed switch 98′ is shown in FIG. 4 and FIG. 5, respectively. The solar panel 15′ can be used to charge a battery so that the pump 90 may be set for continuous 24 hour operation or for operation at any time the diesel engine 30 is not in operation.

Accordingly, the system 10 enables unattended fuel recirculation/polishing ensuring that the fuel does not go bad after periods of sitting idle. The pump controller/timer 80 allows the operator to set how long the system 10 is active or it can be set for continuous use. At 50-100 gallons/day, the slow flow/long duration polishing maximizes the water separation effectiveness of the fuel filters.

The system 10′ is designed to retro fit into an existing fuel circuit. In one embodiment a parallel system is provided just for polishing with lower micron filtration.

Another advantage is that no manual valve is needed to switch from normal operation to polishing mode as the fuel polishing module 70 has an internal automatic diverter.

While the system 10 has been shown as particularly useful in marine applications, the invention is not limited as such, and may also be useful in other applications where diesel fuel contamination is a problem.

Although the principles, embodiments and operation of the present invention have been described in detail herein, this is not to be construed as being limited to the particular illustrative forms disclosed. They will thus become apparent to those skilled in the art that various modifications of the embodiments herein can be made without departing from the spirit or scope of the invention.

What is claimed is:

1. A fuel polishing system comprising:
a fuel tank having a fuel supply line and a fuel return line;
a fuel filter attached to the fuel supply line;
a piezoelectric pump selectively controlled to pump fuel from the fuel tank and through the filter and return the fuel to the fuel tank by directing the fuel to the fuel return line.

2. The fuel polishing system of claim 1 further comprising a battery power source for the piezoelectric pump.

3. The fuel polishing system of claim 2, wherein the battery is recharged by a solar energy panel.

4. The fuel polishing system of claim 1, wherein the piezoelectric pump operates continuously on less than two watts or less than three amp-hours per day.

5. The fuel polishing system of claim 1, wherein the piezoelectric pump operates continuously on less than one watt or less than two amp-hours per day.

6. The fuel polishing system of claim 1, the piezoelectric pump operates to filter about 100 gallons of fuel per day.

7. The fuel polishing system of claim 1, the piezoelectric pump operates to filter about 50 gallons of fuel per day.

8. The fuel polishing system of claim 1, further comprising a programmable timer to control operation of the piezoelectric pump.

9. A fuel polishing system comprising:
a fuel tank having a fuel supply line for supplying fuel to a diesel engine and a fuel return line for returning fuel from the diesel engine to the fuel tank;
a fuel filter attached to the fuel supply line;
a fuel polishing module attached to the fuel supply line, the fuel polishing module comprising a piezoelectric pump adapted to pump fuel from the fuel tank and through the filter and return the fuel to the fuel tank by directing the fuel to the fuel return line, the fuel polishing module including a by-pass line to direct fuel around the piezoelectric pump when the diesel engine is in operation.

10. The fuel polishing system of claim 9, wherein the by-pass line includes a check valve.

11. The fuel polishing system of claim 9, wherein the fuel polishing module comprises a diverter line that returns the fuel return line, wherein the diverter line includes a check valve.

12. The fuel polishing system of claim 9 further comprising a battery power source for the piezoelectric pump.

13. The fuel polishing system of claim 12, wherein the battery is recharged by a solar energy panel.

14. The fuel polishing system of claim 9, wherein the piezoelectric pump operates continuously on less than two watts or less than three amp-hours per day.

15. The fuel polishing system of claim 9, wherein the piezoelectric pump operates continuously on less than one watt or less than two amp-hours per day.

16. The fuel polishing system of claim 9, the piezoelectric pump operates to filter about 100 gallons of fuel per day.

17. The fuel polishing system of claim 9, the piezoelectric pump operates to filter about 50 gallons of fuel per day.

18. The fuel polishing system of claim 9, further comprising a programmable timer to control operation of the piezoelectric pump.

19. A method for polishing fuel comprising the steps of:
inserting a fuel polishing module into an existing fuel supply line between a fuel tank and a diesel engine, the fuel polishing module including a piezoelectric pump;
allowing fuel to by-pass the pump when the diesel engine is in operation such that the fuel flows from the fuel tank to the diesel engine;
pumping the fuel from the fuel tank, through a fuel filter and diverting the fuel back to an existing fuel return line between the diesel engine and the fuel tank when the diesel engine is not in operation.

20. The method of claim 19 comprising the steps of:
powering the fuel polishing module with a battery; and
recharging the battery with a solar power panel.
